(19) United States
(12) Patent Application Publication
(10) Pub. No.: US 2007/0215271 A1
(43) Pub. Date: Sep. 20, 2007

(54) Covering article and associated method

(76) Inventor: Shawn A. McClintic, Glenville, NY (US)

Correspondence Address: SHAWN A. MCCLINTIC, GE GLOBAL RESEARCH, 34 SAINT STEPHENS LANE EAST, GLENVILLE, NY, 12302, US

(21) Appl. No.: 11/366,255

(22) Filed: Mar. 2, 2006

(51) Int. Cl. B32B 37/12; B32B 37/00

(52) U.S. Cl. 156/247; 156/297; 156/299; 156/249; 156/289

(57) ABSTRACT

A covering article and a method of making a covering article are provided. The covering article may include a base layer having a first surface and a second surface and an adhesive layer. The base layer may be elastic, resilient, or elastic and resilient. The adhesive layer may be disposed on the second surface of the base layer, and may be able to adhere to a substrate surface.

### CROSS REFERENCE TO RELATED APPLICATIONS

This application is a non-provisional application claiming priority to provisional U.S. patent application Ser. No. ______, filed ______, and hereby incorporates by reference and claims benefit thereto.

### BACKGROUND

1. Technical Field

The invention includes embodiments that may relate to a covering article. The invention includes embodiments that may relate to a method of making and/or a method of using a covering article.

2. Discussion of Related Art

The interior walls, floors and ceilings of homes may not be as sturdy and resistant to damage as might be desired. Damage may come as, for example, impacts, settling of the house, or stains.

Older homes may be subject to the slow movement of plaster and lathe over time. To accommodate imperfections in walls, floors and ceilings of homes, old and new, several approaches have been tried. Some approaches may use textured paint, while other approaches may use textured wall paper. Unfortunately, paint may peel if poorly adhered to the substrate, and wall paper has had minimal thickness and poor adhesion. Wall paper may further suffer in that, as its name implies, it is a solution designed for walls; ceilings and floors may not be considered within the scope of usage of “wall” paper. As for floors, floor coverings may be considered an entirely different product line from wall and ceiling products owing to the effect of gravity and normal usage differences with regard to the installation and life of the ceiling and wall products relative to flooring products. Similarly, wall coverings and ceiling coverings have differences between them as well. An example of a difference is the viscosity of ceiling paints with regard to wall paints, as ceiling paints tend to have relatively higher application viscosity, higher sag requirements, and faster drying times.

While some wallpaper may hide relatively small imperfections, damage, and defects on walls, it may be desirable to have a product with characteristics and properties that differ from those currently available. Such characteristics and properties may include one or more of usability outside of wall applications; the ability to minimize or hide relatively larger imperfections, damage, and defects; relative ease of installation; and relatively better stain resistance and longer service life.

### BRIEF DESCRIPTION

The invention includes embodiments that may relate to a covering article. The covering article includes a base layer having a first surface and a second surface, the base layer being elastic, resilient, or elastic and resilient; and, an adhesive layer disposed on the second surface of the base layer. The adhesive layer being able to adhere to a substrate surface.

The invention includes embodiments that may relate to a method of covering a substrate. The method includes providing a resilient covering article having a peripheral edge; securing the covering article to a surface of the substrate; abutting portions of the covering article at a seam defined by respective peripheral edges; applying a slight pressure to deform the covering article; and allowing the peripheral edge to return to shape.

Other embodiments may become apparent to one of ordinary skill in the relevant field of art in response to a review of the specification and drawings.

### BRIEF DESCRIPTION OF THE DRAWINGS

FIG. 1 is a schematic diagram showing a cross-sectional side view of a covering article comprising an embodiment in accordance with the invention;

FIG. 2 is a schematic diagram showing a side view of a covering article comprising another embodiment in accordance with the invention;

FIG. 3 is a schematic diagram showing a side view of a covering article comprising another embodiment in accordance with the invention;

FIG. 4 is a schematic diagram showing a side view of a covering article comprising another embodiment in accordance with the invention;

FIG. 5 is a schematic diagram showing a side view of a covering article comprising another embodiment in accordance with the invention;

FIG. 6 is a schematic diagram showing another side view of covering article comprising an embodiment in accordance with the invention; and

FIG. 7 is a schematic diagram showing a side view of portions of covering articles secured to a substrate.

### DETAILED DESCRIPTION

The invention includes embodiments that may relate to a covering article. The invention includes embodiments that may relate to a method of making a covering article. The invention includes embodiments that may relate to a method of using a covering article. In one embodiment, a covering article may be secured to a wall or to a ceiling by an adhesive layer.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In some embodiments, the precision refers to the sensitivity of the measuring device useful to determine the corresponding value.

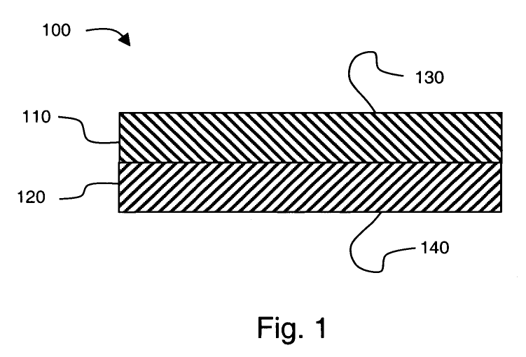

A covering article 100 comprising an embodiment according to the invention is shown in FIG. 1. The covering article 100 may include a base layer 110 and an adhesive layer 120. The base layer 110 may have an outward-facing, exposed surface 130, and the adhesive layer 120 may have an outward-facing, exposed surface 140 that may contact a substrate surface (not shown) during application. Suitable adhesive layers are described hereinbelow.

A suitable base layer may have a patterned thickness, or a substantially uniform thickness, of less than about 25 micrometers, in a range of from about 25 to about 35 micrometers, from about 35 micrometers to about 50 micrometers, from about 50 micrometers to about 1 centimeter, from about 1 centimeter to about 5 centimeter or greater than about 5 centimeter.

In one embodiment, a base layer may be about 2 centimeters thick or thicker, and may be one or more of foamed, elastic, deformable, springy, spongy, or resilient. Slight pressure may temporarily deform the base layer, and when the pressure is relieved, the base layer may return, or attempt to return, to its original shape. Accordingly, if such a base layer is cut, the base layer may ‘reseal’ around the cut, rendering the cut area substantially undetectable. If such a base layer would be abutted to itself along an edge, the base layers may, much. as with the cut area, seal at the seam, rendering the seam substantially undetectable. Slight pressure may include pressure capable of being supplied by fingers. Additionally, an elasticity of the base layer may allow for crack bridging, particularly when combined with a tenacious and strong adhesion from an adhesive layer. In one embodiment, a relatively very thick and open porous base layer, particularly with no cover layer, may absorb sound and/or provide a sound dampening function, and/or a vibration dampening function. Pores, perforations, or channels may be formed in the base layer to allow for egress of air trapped during installation or application.

A base layer may include one or more polymers, and may further include one or more of a filler, additive, or pigment. Suitable polymers, resins, or binders (hereinafter collectively “polymers”) for use in forming a base layer may include thermoplastic material, thermoset material, or a combination of both. In one embodiment, a polymer may include one or more of polyacrylamide, polyacrylate, polyamide, polycarbonate, epoxy, polyester, polyether, ionomer, polyolefin, polystyrene, polyurethane, polyvinyl, silicone, or polysiloxane.

Suitable polyamide polymers may include polymers commercially available from EMS American Grilon Inc., (Sumter, S.C.) under the tradename GRIVORY such as CF6S, CR-9, XE3303 and G-21. GRIVORY G-21 may be an amorphous nylon copolymer having a glass transition temperature (Tg) of 125 degrees Celsius, a melt flow index of 90 g/10 min and an elongation at break of 15. Elongation at break may be determined with reference to ASTM D638, which is hereby incorporated by reference in its entirety. GRIVORY CF65 may be a nylon 6/12 film grade polymer having a melting point of 135 degrees Celsius, an MFI of 50 g/10 min, and an elongation at break in excess of 350%. GRILON CR9 may be a nylon 6/12 film grade polymer having a melting point of 200 degrees Celsius, an MFI of 200 g/10 min, and an elongation at break at 250%. GRILON XE 3303 may be a nylon 6.6/6.10 film grade polymer having a melting point of 200 degrees Celsius, an MFI of 60 g/10 min, and an elongation at break of 100%. Suitable polyamide polymers may include those available from, for example, Union Camp, Inc. (Wayne, N.J.) under the UNI-REZ product line, and dimer-based polyamide polymers available from Henkel of America, Inc. (Gulph Mills, Pa.) under the VERSAMID product line. Suitable polyamides may include those produced by condensing dimerized vegetable acids with hexamethylene diamine.

Suitable polycarbonates may include those commercially available from the CALIBRE, from Dow Chemical Co. (Midland, Mich.), LEXAN, from GE Plastics (Pittsfield, Mass.), and MAKROLON, from Bayer Corporation (Pittsburgh, Pa.). Other suitable polycarbonates may be obtained by a reaction of bisphenol A and carbonyl chloride in an interfacial process. Suitable molecular weight may be less than about 20,000, in a range of from about 20,000 to about 35,000, or greater than about 35,000; and a suitable melt flow rate may be less than about 5 g/10 min, in a range of from about 5 to about 20 g/10 min, or greater than about 20 g/10 min.

Suitable polyesters may include one or both of polyethylene terephthalate (PET) or PETG (PET modified with cyclohexanedimethanol). Polyesters may be obtained commercially, such as KODAR 6763, a PETG available from Eastman Chemical (Rochester, N.Y.), or SELAR PT-8307 a PET available from DuPont Corporation (Wilmington, Del.). Other suitable polyesters may be prepared from various glycols or polyols and one or more aliphatic or aromatic carboxylic acids.

An ionomer is a polyolefin containing ionic bonded molecular chains. In one embodiment, ionomers may be used. Suitable ionomers may include ionomeric ethylene copolymers such as SURLYN 1702 or SURLYN 1706, both available from DuPont, and which may include an inter-chain ionic bond based on a zinc salt of ethylene methacrylic acid copolymer.

Suitable polyolefins may include one or more of: polyethylene, polypropylene, or may include ethylene or propylene units, and may include oxygenated or halogenated derivatives of ether, butadiene, oxygenated butadiene, isoprene, oxygenated isoprene, butadiene styrene, butadiene vinyl toluene, isoprene styrene and the like; polymers or copolymers containing units of acrylic acid, methacrylic acid, their esters, or acrylonitrile; vinylic hydrocarbon monomers reacted with unsaturated materials such as the reaction product of maleic acid or anhydride with styrene; and, polymerous rubber-like elastomeric latex polymers and copolymers of ethylenically unsaturated monomers and polymers obtainable in stable aqueous latex form. In one embodiment, a polyolefin may be halogenated, such as polytetrafluoroethylene.

Suitable polyolefins may be characterized as having a melt index or melt flow rate of less than about 10, in a range of from about 10 to about 20, or greater than about 30 as determined by ASTM Test Method 1238, which is hereby incorporated by reference in its entirety. A polyolefin may include polymers and copolymers of ethylene, propylene, 1-butene, and the like, and may further include blends and mixtures of such polymers and copolymers.

Suitable polyethylene polyolefins may include low, medium, or high density polyethylene, or combinations of two or more thereof. A low density range for a polyethylene may in a range of from less than about 0.910 grams per cubic centimeter (g/cm³) to about 0.925 g/cm³, a medium density range may be from about 0.925 g/cm³ to about 0.940 g/cm³, and a high density range may be from about 0.940 g/cm³ to greater than about 0.965 g/cm³. A low density polyethylene (LDPE) may be REXENE 1017, which is commercially available from Huntsman Corporation (Houston, Tex.).

Suitable propylene polyolefins may include polypropylene homopolymer, or a copolymer, such as propylene-ethylene or propylene-1-butene copolymer. Blends of polypropylene and polyethylene with each other, or blends of either or both of them with a polypropylene-polyethylene copolymer may be used. The polyolefin film forming materials may have a high propylenic content, either polypropylene homopolymer or propylene-ethylene copolymers or blends of polypropylene and polyethylene with low ethylene content, or propylene-1-butene copolymers or blend of polypropylene and poly-1-butene with low butene content.

Suitable propylene homopolymers may have a melt flow rate (MFR) from about 0.5 to about 20 as determined by ASTM Test D 1238, condition L. In one embodiment, propylene homopolymers may have a melt flow rate (MFR) or a melt flow index (MFI) of less than about 4 grams per 10 minutes (g/10 min), and in a range of from about 4 g/10 min to about 8 g/10 min, from about 8 g/10 min to about 10 g/10 min, or greater than about 10 g/10 min. Here and throughout the specification and claims, range limitations may be combined and interchanged, for example, the above MFR or MFI range may be from less than about 4 g/10 min to greater than about 10 g/10 min. As used herein, MFR and MFI may be determined with reference to DIN 53735, which is hereby incorporated by reference in its entirety. Suitable propylene homopolymers may have a density less than about 0.8 g/cm³, in a range of from about 0.8 g/cm³ to about 0.9 g/cm³, or greater than about 0.9 g/cm³. Commercially available propylene homopolymers may include 5A97, available from Union Carbide Corporation (Danbury, Conn.), which has an MFR of 12.0 g/10 min and a density of 0.90 g/cm³; DX5E66, also available from Union Carbide, has an MFI of 8.8 g/10 min and a density of 0.90 g/cm3; and WRD5-1057 from Union Carbide having an MFI of 3.9 g/10 min and a density of 0.90 g/cm³.

Suitable polystyrene may include homopolymers and/or copolymers of styrene, and may include substituted styrene such as alpha-methyl styrene. Examples of suitable styrene copolymers and terpolymers may include one or more of acrylonitrile-butene-styrene (ABS), styrene-acrylonitrile copolymers (SAN), styrene butadiene (SB), styrene-maleic anhydride (SMA), or styrene-methyl methacrylate (SMMA), and the like.

A suitable polymer may include one or more polyurethane. Suitable polyurethanes may include diphenylmethane diisocyanate, methylene diethyl diisocyanate, isocyanurate. Suitable polyurethanes may include aliphatic polyurethanes. Other suitable polyurethanes may include aromatic polyurethanes. Polyurethanes having a cyclic moiety may be suitable, and combinations of one or more of aliphatic, aromatic, or cyclic may be suitable also.

In one embodiment, a vinyl polymer, such as alkylene vinyl acetate polymers (e.g., EVA polymer) may be used. Suitable commercially available vinyl polymers may include ESCORENE UL-7520, a copolymer of ethylene with 19.3% vinyl acetate; and NUCRELL 699), an ethylene copolymer containing 11% of methacrylic acid. ESCORENE and NUCRELL are available from Exxon Mobil Corporation (Irving, Tex.) and DuPont Corporation, respectively. In addition, suitable vinyl polymers may include one or more of vinyl- and vinylidene-based polymers or copolymers containing units such as polyvinyl chloride, polyvinyl butyral, polyvinyl acetal, polyvinyl acetoacetal, polyvinylidene fluoride, polyvinylidene chloride, polyvinyl alcohol, or polyethylene vinyl alcohol, and the like, and combinations of two or more thereof.

Suitable polysiloxanes may be entirely inorganic, may have an inorganic backbone with organic side groups, or may be formed from organic modified precursors. In one embodiment, a suitable siloxane may include an alkoxy moiety, a glycidyl or epoxy moiety, a cyano or cyanato moiety, an amino moiety, a mercapto moiety, or a combination of moieties that include two or more thereof. Suitable organic side groups may include from about 1 to about 100 carbon atoms and may have an aliphatic, cyclic and/or aromatic character. Suitable organic modified precursors for the polysiloxane include acrylic, urethane and epoxy functional monomers or oligomers.

A suitable polysiloxane may be formed using a sol-gel process or a condensation reaction, particular from silane precursors. A siloxane according to one embodiment may be air-dried at room temperature, or may be heat dried, or heat cured. In one embodiment, the siloxane may be polymerized or cured by exposure to radiation. Suitable radiation may include one or more of ultraviolet, infrared, electron beam, and/or visible light. Cross linking or curing of the siloxane material may depend on the choice of siloxane material and the functionality thereof. In one embodiment, the siloxane may be chemically initiated to form linkages. Commercially available cross linking or curing methods may be determined with reference to the selection of siloxane material, and may include ambient cure systems, thermal cure systems, radiation cure systems, moisture cure systems, and one and two part curing agent or cross link initiating systems.

In one embodiment, a silane and/or polysilane may have an alkoxy moiety, such as mono, di, tri, and tetralkoxy functionality. For example, preselected alkoxy silanes may be mixed with water to hydrolyze the alkoxysilane into silanol and alcohol. In one embodiment, a suitable silane may include a glycidyl moiety, an amino moiety, a cyano or cyanato moiety, a mercapto moiety, or a combination of moieties that include two or more thereof. In one embodiment, the silane may include one or more of glycidoxyproyl trimethoxy silane, 1,2 bis(triethoxysilyl)ethane, gamma-aminopropyl triethoxy silane, mercaptoproyl trimethoxy silane, polydimethylsilane, vinyl silane, aminopropyl silane, epoxy silane, or vinyl triactosilane. A suitable silane may include a non-hydrolyzable functional group. Such groups may include amino, vinyl, ureido, epoxy, mercapto, isocyanato, methacrylato, vinylbenzene and sulfane functional groups. Examples of suitable silanes may include vinyltrimethoxysilane, bis-triethoxysilylpropyl tetrasulfane, amino trimethoxysilane, and ureidopropyl trimethoxysilane. Other examples of suitable silanes may include 1,2 bis-(triethoxysilyl)ethane, 1,2-bis-(trimethoxysilyl)ethane, 1,6-bis-(trialkoxysilyl)hexane, 1,2-bis-(triethoxysilyl)ethylene, or bis-triethoxysilylpropyl tetrasulfane.

Suitable polysiloxanes may include ADSIL AD-65 or ADSIL AD-95, which are commercially available from Adsil Corporation (Palm Coast, Fla.). In one embodiment, a suitable silicon-containing material may include SDC TECH MP-100, which is commercially available from SDC Technologies, Inc. (Anaheim, Calif.). A suitable silane may include an ECOSIL brand product, which may be obtained from Epro Services, Inc. (Derby, Kans.).

Other suitable polymers may include one or more of urea formaldehyde, phenolformaldehyde, phenolic polymers, carbon-carbon composites, and fibrin polymers, and the like.

One or more pigments and/or fillers may be included in a matrix of a base layer. A suitable pigment may include one or more of opacifying pigments, tinting pigments, or filler pigments. A suitable opacifying pigment may include a metal oxide, such as titanium dioxide, tin oxide, or zinc oxide.

A suitable tinting pigment may include organic materials, metal oxides, or both. A suitable tinting organic material may include one or more of carbon black, raw and burnt sienna or umber, phthalocyanine blue, phthalocyanine green, ultramarine blue, as well as organic reds such as azo reds, quinacridone red and perylene red as well as organic yellows such as diarylide yellow, and the like. Suitable tinting metal oxide pigments may include one or more of yellow oxides, brown oxides, tan oxides, chromium oxide green, cadmium pigments, chromium pigments, and the like, and/or mixed metal oxides.

A suitable filler pigment may include one or more of clay; silica; talc; mica; magnetic particles; a cellulosic, such as wood flour or cork pieces; a sulfate, such as barium sulfate; a carbonate, such as calcium carbonate; a silicate such as wollastonite (calcium silicate) or aluminum silicate; and the like, and combinations of two or more thereof. In one embodiment, no pigment is present. In one embodiment, a pigment may be chemically reactive with a matrix, and may provide a reinforcing function to a layer. In one embodiment, a pigment may be shaped as a particle, rod, whisker, fiber, chopped fiber, plate, star, bowl, and the like, and combinations of two or more thereof.

A suitable total amount of pigment may be added that may be less than about 1 weight percent, in a range of from about 1 weight percent to about 5 weight percent, in a range of from about 5 weight percent to about 10 weight percent, from about 10 weight percent to about 25 weight percent, from about 25 weight percent to about 50 weight percent, or greater than about 50 weight percent based on the total weight of the formulation. In one embodiment, cellulosic particles, used as a filler, may be combined with a thick base layer (e.g., a closed cell foam layer) to create a cork board effect. That is, a covering article that has an appearance of cork board, and functions to accept and retain pins stuck thereinto.

An optional solvent may be present prior to, and/or during, installation or application of a covering article to a substrate surface. The solvent may evaporate after application to the substrate surface to leave a solid, dry film layer secured to the substrate surface. If a solvent is present, suitable solvents may include one or more organic based solvent, such as a ketone, ester, aliphatic compound, aromatic compound, alcohol, glycol, glycol ether, and the like, and combinations of two or more thereof. Suitable ketones may include one or more of methylethyl ketone (MEK), methylisobutyl ketone (MIK or MIBK), ethyl acetate, white spirits, alkanes, cycloalkanes, benzene, hydrocarbon substituted aromatic compounds (e.g., toluene, xylene and the like, and combinations of two or more thereof), and isoparaffinic solvents, and combinations of two or more thereof. Alternatively, water, or an aqueous solution, may be used to form an emulsion with the polymer. A suitable aqueous solution may include water-alcohol mixtures, and the like. The solvent or water may be volatile so that when applied to a substrate, the solvent evaporates leaving behind the polymer, and pigment (if used) and any other additional non-volatile ingredients.

An organic solvent amount, water amount, or, in the case of an emulsion—a water and organic solvent amount, may be less than about 10% relative to a polymer weight. In one embodiment, the water, the organic solvent, or both may be present in an amount in a range of from about 10% to about 25%, from about 25% to about 50% by weight, or greater than about 50% by weight. Suitable emulsions may include water-in-oil (WO), oil-in-water (OW), water-in-oil-in-water (WOW), and oil-in-water-in-oil (OWO) emulsion types. In one embodiment, the discontinuous phase may include substantially spherical droplets having a diameter in the microscale range.

Additional ingredients in a base layer polymer may include one or more wetting agent; plasticizer; suspension agent; thixotropic agent, such as silica; water repellant additive, such as a polysiloxane compound; fire retardant additive; biocide and anti-mildew agent; defoamer; flow agent; flexibilizer; elastomer; UV blocker; anti-oxidant; and the like. A suitable plasticizer may be migratory or non-migratory. Preferred migratory plasticizers may include a high-boiling solvent or a softening agent, which may be liquid at room temperature. In one embodiment, a plasticizer may include an ester made from an anhydride or acid and a suitable alcohol having from about 6 to about 13 carbon atoms. Other suitable plasticizers may include one or more of adipate, phosphate, benzoate or phthalate esters, polyalkylene oxides, sulfonamides, and the like. Plasticizers may include DOA plasticizer (dioctyl adipate), TEG-EH plasticizer (triethylene glycol di-2-ethylhexanoate), TOTM plasticizer (trioctyl trimellitate), triacetin plasticizer (glyceryl triacetate), TXIB plasticizer (2,2,4-trimethyl-1,3-pentanediol diisobutyrate), DEP plasticizer (diethyl phthalate), DOTP plasticizer (dioctyl terephthalate), DMP plasticizer (dimethyl phthalate), DOP plasticizer (dioctyl phthalate), DBP plasticizer (dibutyl phthalate), polyethylene oxide, toluene sulfonamide, and dipropylene glycol benzoate. Other commercially available plasticizers may be interchangeable therewith.

A Suitable antioxidant may provide radical trapping activity and may be selected with reference to at least some of the following considerations: the compatibility with the resin, the effective stability of the antioxidant at processing temperatures, whether the antioxidant may cause undesirable coloring, and that the antioxidant may not interact with other additives. Further, a suitable antioxidant should inhibit aging during processing, during storage, and during the end use. Suitable antioxidants may include one or more of tert-butylhydroquinone, propyl gallate, sodium nitrate, sodium nitrite, butylated hydroxytoluene (BHT), butylated hydroxyanisole (BHA), and analogs, derivatives and combinations thereof. Suitable additive materials may be commercially available from such suppliers as Ciba Specialty Chemicals, Inc. (Tarrytown, N.Y.) and Ferro Corp. (Independence, Ohio); unless specified otherwise, equipment and ingredients referred to herein throughout the specification and claims may be commercially available from such common chemical suppliers as Sigma Aldrich, Inc. (St. Louis, Mo.), Alfa Aesar, Inc. (Ward Hill, Mass.), and/or Fisher Scientific International, Inc. (Hanover Park, Ill.).

Other suitable additional ingredients may include a nucleating agent. In one embodiment, a nucleating agent may increase crystallinity and thereby increase stiffness. Nucleating agents may include one or both of mineral nucleating agents and organic nucleating agents. Suitable mineral nucleating agents may include one or more of silica, silicate, clay, kaolin, and talc. Suitable organic nucleating agents may include one or more of carbon black or an organic salt. Suitable organic salts may include aliphatic mono-basic or di-basic acids or aryalkyl acid, such as sodium succinate, sodium glutarate, sodium caproate, sodium 4-methylvalerate, aluminum phenyl acetate, or sodium cinnamate. Suitable organic salts may include also an alkali metal and aluminum salt of an aromatic or alicyclic carboxylic acid, such as aluminum benzoate, sodium or potassium benzoate, sodium betanaphtholate, lithium benzoate and aluminum tertiary-butyl benzoate also are useful organic nucleating agents. Suitable organic salts may include also a substituted sorbitol derivative, such as bis(benzylidene) or bis(alkylbenzilidine) sorbitols, wherein the alkyl groups contain from about 2 to about 18 carbon atoms, for example, 1,3,2,4-dibenzylidene sorbitol, 1,3,2,4-di-para-methylbenzylidene sorbitol, or 1,3,2,4-di-para-methylbenzylidene sorbitol.

Additional ingredients may be present in a concentration or amount, relative to a polymer, of less than about 0.1% by weight. In one embodiment, the ingredient amount may be in a range of from about 0.1% to about 1% by weight, from about 1% to about 5% by weight, or greater than about 5% by weight. With reference to an amount of nucleating agent incorporated into a base film, a suitable amount may be in a range of from about 100 parts per million (ppm) to about 1000 ppm, from about 1000 ppm to about 5000 ppm, or from about 5000 ppm to about 6000 ppm, relative to the weight of the base film.

Suitable methods for making a base layer may include extrusion, co-extrusion, casting, coating, or other film forming method. In one embodiment, a base layer may include a single layer. In one embodiment, a base layer may include two or more layers. A base layer may be a continuous layer, and may be uninterrupted, or may define areas of discontinuity. Each of the two or more layers of a multi-layer base layer may have the same formulation or a different formulation, the same color or a different color, the same degree of transparency/opacity or a different degree of transparency/opacity, and/or the same physical properties or different physical properties (such as elongation, fire retardency, electrostatic dispersion (ESD), water resistance, and the like). In one embodiment, a base layer may have a first sub-layer that may provide background color, while a second, overlaying sub-layer may provide a pattern or design. For example, the sub-layers may cooperate with each other to provide a faux finish, such as a “ragging” or “sponging” look, or may provide a desired print or design image (e.g., a flowered design) having one or multiple colors. The designs may be in the form of repeat designs or random non-repeat designs. In one embodiment, a perceived depth may be provided by overlaying sub-layers of increasing opacity/transparency. Similarly, a holographic effect may be achieved by including a sub-layer having holographic pigment admixed therein or secured thereto.

Alternatively or additionally, electronically responsive devices may be disposed within or onto a base layer. Such devices, such as a light emitting diode (LED) may be subsequently activated to provide light in response to a predetermined stimulus. In one embodiment, the LED is one of a plurality of like or dissimilar devices and the plurality defines a pattern that can display images through the selected activation of groups of LEDs of the plurality.

An adhesive layer for use in embodiments of the invention may include a curable adhesive, a structural adhesive, a pressure sensitive adhesive, and the like, or a combination of two or more thereof. In one embodiment, an adhesive layer may include an emulsion-based adhesive or a solvent-based adhesive. In one embodiment, the adhesive may be a hot-melt adhesive. In one embodiment, the adhesive may be a pressure-activated adhesive. A suitable adhesive for use in an adhesive layer may include one or more of hot-melt adhesives, moisture curable adhesives, pressure-activated adhesives, and radiation curable adhesives, and the like. As used herein, a structural adhesive, when fully adhered to a substrate, has an adhesive strength equal to or greater than the cohesive strength of the adhesive, the substrate, or both. A pressure-activated adhesive may have a curing agent or initiator admixed within, and may respond to pressure by releasing the curing agent or initiator and thereby begin a curing process of the adhesive. Solvent-based adhesives may include those adhesives that form adhesive properties in response to an evaporation or loss of a solvent initially contained in the adhesive. A hot melt adhesive may flow and liquefy under high temperatures, and may form adhesive properties upon cooling.

In one embodiment, a method of making a suitable adhesive may include: (1) preparing a polymer mixture comprising one or more polymerizable polymers; (2) polymerizing the polymer mixture to form a polymerized mixture; (3) modifying the polymerized mixture with a modifying polymer; and (4) neutralizing the resulting modified mixture.

A suitable adhesive layer may have a patterned thickness, or a substantially uniform thickness, of less than about 25 micrometers, in a range of from about 25 to about 35 micrometers, from about 35 micrometers to about 50 micrometers, or greater than about 50 micrometers.

In one embodiment, an adhesive layer may be continuous. In one embodiment, an adhesive layer may be discontinuous. A discontinuous adhesive layer define a pattern of areas having adhesive and other areas that are adhesive-free, or substantially adhesive-free. Alternatively or additionally, an adhesive layer may include two or more adhesives having differing properties. For example, a first adhesive with a relatively strong adhesive strength may be disposed in some areas, but a second adhesive with a relatively weak adhesive strength may be disposed in other areas. In one embodiment, first and second adhesive materials are disposed at different heights relative to each other. A weak adhesive may protrude further than a strong adhesive, so that the weak adhesive may contact a substrate first during an application. In such a situation, the weak adhesive layer may provide initial tack for positioning, but may allow slight movement of the laminate to allow positioning adjustments prior to the stronger adhesive forming a relatively more permanent bond. Such an arrangement may facilitate slideability, repositioning, smoothing, and/or air egress.

A suitable adhesive layer may include two or more differing adhesives. In one embodiment, an adhesive layer may include a pressure sensitive adhesive (PSA), and may further include one or more of a moisture activatable adhesive, a hot-melt adhesive, a two-component adhesive as described herein, a solvent or water-based adhesive, or a heat activatable adhesive layer. In one embodiment, differing adhesive are commixed or commingled, and in one embodiment, differing adhesives may be substantially unmixed, but in the same adhesive layer. In one embodiment, an adhesive layer may be discontinuous, and differing adhesive materials may be disposed throughout portions of the discontinuous adhesive layer to provide differing adhesive functionality.

In one embodiment, a curing adhesive may be a radiation-initiated adhesive. Suitable radiation-initiated adhesives may include ultraviolet (UV) curable adhesives and electron beam (EB) curable adhesives, also, heat and infrared (IR) curable adhesives may be included. Suitable chemical-initiated adhesives may include

A suitable curing adhesive may include chemically activated two-part adhesives, which may by cured by contact with a surface primer or adhesion initiator. Suitable two-component adhesives for use with an adhesion initiator may include a thermosetting, anaerobically curable polymeric polymer system that may contact the adhesion initiator and cure in response to contacting the same. Suitable adhesion initiators may include an organocopper catalyst, such as LOCTITE 7469 PRIMER, which is commercially available from Henkel Loctite Corp. (Rocky Hill, Conn.). In other embodiments, suitable alternative adhesion initiators may include other metallic catalysts, such as organo-iron catalysts, zirconium complexes (such as K-KAT XC-9213), metal chelates (such as NACURE XC-9206), and antimony-based catalysts (such as NACURE XC-7231), all of which are commercially available from King Industries, Inc. (Norwalk, Conn.). Other suitable adhesion initiators in alternative embodiments may include nitrogen and sulfur based catalysts.

A suitable adhesive for use in an adhesive layer may include one or more polymer selected from acrylates, amides, acrylonitriles, carbonate, cyanate esters, cyanurates, ethylene-vinyl acetate, epoxy, fluoroplastics, ionomers, methyl methacrylates, non-ethylenic olefin polymers (linear or branched), nylon, olefins, polyester, styrene, styrene-maleic anhydride, sulfones, styrene-acrylonitrile, urethanes, and combinations of two or more thereof. In one embodiment, an adhesive may include an ethylenically unsaturated polymer that is capable of undergoing polymerization or copolymerization. As used herein, binder, resin, monomer, and unsaturated polymer may be collectively referred to collectively as a polymerized end product or “polymer”.

As noted above, a suitable adhesive may include an acrylate polymer. A suitable acrylate may include those derived from ethylene methacrylic acid, ethylene methyl acrylate, ethylene acrylic acid and ethylene ethyl acrylate. Additional suitable acrylic polymers may include ethoxylated trimethylol propane triacrylate, trimethylol propane trimethacrylate, dipentaerythritol monohydroxy pentacrylate, pentaerythritol triacrylate, ethoxylated trimethylol propane triacrylate, 1,6-hexanedioldiacrylate, neopentyl glycol diacrylate, pentaerythritol tetraacrylate, 1,2-butylene glycoldiacrylate, trimethylopropane ethoxylate trimethacrylate, glyceryl propoxylate trimethacrylate, trimethylolpropane trimethacrylate, dipentaerythritol monohydroxy pentamethacrylate, tripropylene glycol dimethacrylate, neopentyl glycol propoxylate dimethacrylate, 1,4-butanediol dimethacrylate, polyethylene glycol dimethacrylate, triethyleneglycol dimethacrylate, butylene glycol dimethacrylate, ethoxylated bisphenol A dimethacrylate, and the like, and combinations of two or more thereof.

In one embodiment, an acrylic polymer may be formed from alkylene glycol diacrylate polymers. Such alkylene glycol diacrylate polymers may be selected from mono-, di-, tri-, tetra- and polyethylene glycol dimethacrylate and corresponding diacrylates; dipentamethylene glycol dimethacrylate; tetraethylene glycol dichloroacrylate; diglycerol diacrylate; diglycerol tetramethacrylate; butylene glycol dimethacrylate; neopentyl glycol diacrylate; and trimethylopropane triacrylate. In one embodiment, suitable amino polymers may include substituted and/or unsubstituted aminoalkyl acrylates, hydrochloride salts of amino polymers, and methacrylates, such as beta-amino ethylacrylate, beta-amino ethyl ethacrylate, dimethyl amino methylacrylate, beta-methyl amino ethylacrylate, and dimethyl amino methylmethacrylate.

In one embodiment, an alkyl acrylate and/or methacrylate may include from about 4 carbon atoms to about 10 carbon atoms, from about 10 carbon atoms to about 20 carbon atoms, or more than about 20 carbon atoms. An acrylate may be copolymerized with a modifying polymer (for example, a second acrylic ester) and/or polymers with predetermined functional groups (e.g., acrylic, methacrylic, itaconic acids, and amides thereof). Suitable polymers may include butyl acrylate, 2-ethylhexyl acrylate, and iso-octyl acrylate.

In one embodiment, an acrylate polymer may include further one or more functional oxiranyl (oxirane) groups. In one embodiment, an acrylate polymer may include further one or more functional urethane groups, such as in a urethane-acrylate-capped prepolymer, which may be based on polybutadiene polyols, or based on polyamines and acrylates.

In one embodiment, a monofunctional acrylate ester (esters containing one acrylate group) may be used. A suitable acrylate ester may have a relatively polar moiety. Polar groups may be selected from labile hydrogen, heterocyclic ring, hydroxy, amino, cyano, and halogen polar groups; examples may include cyclohexyl methacrylate, tetrahydrofurfuryl methacrylate, hydroxyethyl acrylate, hydroxypropyl methacrylate, t-butylaminoethyl methacrylate, cyanoethylacrylate, and chloroethyl methacrylate. Acrylate esters may be incorporated as reactive diluents capable of copolymerizing with various other polymerizable materials.

Suitable amides of carboxylic acids may include unsubstituted amides such as methacrylamide, alpha-substituted acrylamides, and n-substituted amides obtained by the reaction of the amides of the aforementioned carboxylic acids with an aldehyde (e.g., formaldehyde). In one embodiment, n-substituted amides may include one or more of n-methylol acrylamide, n-methylol methacrylamide, alkylated n-methylol acrylamides, and n-methylol methacrylamides (e.g., n-methyoxymethylacrylamide and n-methoxy methyl methacrylamide). Suitable nitriles, that is, ethylenically unsaturated carboxylic acids, may include acrylonitrile, alpha-chloroacrylonitrile, and methacrylonitrile.

Suitable polyepoxide resins may be solid or liquid at room temperature. Suitable epoxides may include linear polymers having terminal epoxide groups (e.g., the diglycidyl ether of bisphenol-A), polymers having pendent epoxy groups (e.g., polyglycidyl ethers of phenolic novolak compounds), or both.

In one embodiment, an adhesive may include one or more of aromatic epoxy, aliphatic epoxy, or cycloaliphatic epoxy, and may have multiple epoxy functional groups. Suitable aromatic polyepoxides may include two or more 1,2-cyclic ethers. Such compounds may be aromatic or heteroaromatic, or a combination thereof. Aromatic polyepoxide may be included in an adhesive layer to increase the glass transition temperature (Tg) of a cured adhesive layer and to provide heat resistance.

Suitable aromatic epoxides (i.e., compounds containing at least one aromatic ring structure, e.g., a benzene ring, and at least two epoxide groups) may include one or more of polyglycidyl ethers of polyhydric phenols, such as Bisphenol-A or Bisphenol-F type resins and their derivatives, aromatic polyglycidyl amines (e.g., polyglycidyl amines of benzenamines, benzene diamines, naphthylenamines, or naphthylene diamines), polyglycidyl ethers of phenol formaldehyde resole or novolak resins; resorcinol diglycidyl ether; polyglycidyl derivatives of fluorene-type resins; and glycidyl esters of aromatic carboxylic acids, e.g., phthalic acid diglycidyl ester, isophthalic acid diglycidyl ester, trimellitic acid triglycidyl ester, and pyromellitic acid tetraglycidyl ester.

In one embodiment, an aromatic polyepoxide may include polyglycidyl ethers of polyhydric phenols, such as the series of diglycidyl ethers of Bisphenol-A, commercially available from Resolution Performance Products, Inc. (Houston, Texas), for example, under the trade designations “EPON 828” and “EPON 1001F” and the series of diglycidyl ethers of Bisphenol-A and Bisphenol F and their blends, commercially available from Resolution Performance Products, Ltd. (Pernis, The Netherlands), for example, under the trade designations “EPIKOTE 232” and “EPIKOTE 1001”. Other useful commercially available aromatic epoxides include the “DER” series of Bisphenol epoxides and “DEN” series of epoxy novolak resins, available from Dow Chemical Corporation (Midland, Mich.); diglycidyl ether of fluorene Bisphenol, available from Resolution Performance Products, under the trade designation “EPON HPT Resin 1079”; a triglycidyl derivative of p-aminophenol, commercially available from Ciba Performance Polymers, Inc. (Brewster, N.Y.), under the trade designation “MY 0500”; a tetraglycidyl derivative of methylene dianiline, commercially available from Ciba Performance Polymers, under the trade designation “MY 720”; and a polyfunctional aromatic epoxide resin commercially available from Resolution Performance Products under the trade designation “EPON SU-8.” Flame retardant epoxides may also be used, for example, the flame retardant brominated Bisphenol-A diglycidyl ether, commercially available from Dow Chemical Corporation, under the trade designation “DER 580”. The term “derivative” as used herein with reference to thermosetting materials refers to a base molecule with additional substituents that do not interfere substantially with the thermosetting curing reaction of the base molecule.

In one embodiment, an adhesive may include one or more of N,N″-diglycidyl-p-aminophenyl-glycidyl ether, triglycidyl p-aminophenol derived resins, 1,3,5-triglycidyl isocyanurate, tetraglycidylmethylenedianiline, or a glycidyl ether derivative of a novolac resin.

Suitable methacrylic acid esters may include one or more C1-C17 alkyl methacrylates. In one embodiment, methacrylic esters may include methyl methacrylate, ethyl methacrylate, isopropyl methacrylate, n-butylmethacrylate, isobutylmethacrylate, hexyl acrylate, 2-ethylhexyl methacrylate, t-butyl methacrylate, 3,3-dimethylbutyl methacrylate, and lauryl acrylate.

Suitable adhesives may include block copolymers of vinyl aromatic hydrocarbons and conjugated dienes. Block copolymers may be diblock, triblock, multiblock, starblock, polyblock or graftblock copolymers. Throughout the specification and claims, the term ‘block’, as used in diblock, triblock, multiblock, polyblock, and graft or grafted block, refers to the polymer building block used to make the block copolymer. Such block copolymers may have structures represented by the formulae AB, ABA, ABAB, BAB, ABBA, and the like, where A may be a hard or crystalline polymer block of, for example, a vinyl aromatic hydrocarbon or a conjugated diene/vinyl aromatic hydrocarbon tapered copolymer block; and B may a rubbery polymer block of, for example, a conjugated diene. Suitable multi block copolymers may include linear and/or radially symmetric, and/or linear and/or radially asymmetric copolymers.

In one embodiment, an adhesive may include rubber based elastomer materials such as linear, branched, graft or radial block copolymers represented by the diblock structures A-B, the triblock A-B-A, the radial or coupled structures (A-B)n, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may include from about 75% to about 95% by weight of rubbery segments and from about 5% to about 25% by weight of non-rubbery segments.

The non-rubbery segments or hard blocks include polymers of mono- and polycyclic aromatic hydrocarbons, and more particularly vinyl-substituted aromatic hydrocarbons which may be monocyclic or bicyclic in nature. The rubbery blocks or segments are typically polymer blocks of homopolymers or copolymers of aliphatic conjugated dienes. Rubbery materials such as polyisoprene, polybutadiene, and styrene butadiene rubbers may be used to form the rubbery block or segment. The rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

Suitable block copolymers may be prepared using one or more of sequential addition of polymer, incremental addition of polymer, or coupling techniques. Tapered copolymer blocks can be incorporated into multiblock copolymers, for example, by copolymerizing a mixture of conjugated diene and vinyl aromatic hydrocarbon polymers utilizing a difference in copolymerization reactivity rates.

In one embodiment, a conjugated diene may be utilized to prepare an adhesive polymer and/or copolymer. Suitable conjugated dienes may from 4 carbon atoms to about 6 carbon atoms, or from about 6 carbon atoms to about 10 carbon atoms, or more than about 10 carbon atoms. Examples of suitable conjugated dienes may include one or more of 1,3 butadiene, 2 methyl 1,3 butadiene(isoprene), 2,3 dimethyl 1,3 butadiene, chloroprene, 1,3 pentadiene, 1,3 hexadiene, and the like. In one embodiment, an adhesive polymer may include a conjugated diene selected from isoprene, 1,3 butadiene, or both.

Examples of suitable vinyl aromatic hydrocarbons which may be utilized to prepare copolymers may include styrene and/or a substituted styrene or styrene derivative. Suitable styrene derivatives may include o-methylstyrene, p-methylstyrene, p-tert butylstyrene, 1,3-dimethylstyrene, alpha methylstyrene, beta methylstyrene, p-isopropylstyrene, 2,3 dimethylstyrene, o-chlorostyrene, p-chlorostyrene, o-bromostyrene, 2-chloro-4-methylstyrene, and the like. In one embodiment, an adhesive polymer may include styrene.

A number average molecular weight of suitable block copolymers, for example prior to hydrogenation, may be less than about 20,000, in a range of from about 20,000 to about 40,000, from about 40,000 to about 300,000, from about 300,000 to about 500,000, or greater than about 500,000. An average molecular weight of the individual blocks within a copolymer may pre-selected with reference to application specific criteria. In one embodiment, a vinyl aromatic block may have a number average molecular weight of less than about 2000, in a range of from about 2000 to about 4000, from about 4,000 to about 60,000, from about 60,000 to about 125,000, or greater than about 125,000. A conjugated diene block may have number average molecular weight of less than about 10,000, in a range of from about 10,000 to about 35,000, from about 35,000 to about 150,000, from about 150,000 to about 450,000, or greater than about 450,000.

In one embodiment, a block copolymer may contain a ratio of conjugated diene to vinyl aromatic hydrocarbons having less than about 40 weight percent, from about 40 weight percent to about 50 weight percent, or greater than about 50 weight percent of conjugated diene relative to vinyl aromatic hydrocarbon.

Prior to hydrogenation, a vinyl content of a conjugated diene portion may be less than about 10 weight percent, in a range of from about 10 weight percent to about 80 weight percent, or may be greater than about 80 weight percent. Vinyl content may be less than about 25 weight percent, in a range of from about 25 weight percent to about 35 weight percent, from about 35 weight percent to about 55 weight percent, or may be greater than about 55 weight percent. In one embodiment, an elasticity of a modified block copolymer may be controlled by pre-selecting a vinyl content thereof. Vinyl content of the block copolymer may be determined, for example, using nuclear magnetic resonance.

Examples of suitable diblock copolymers (AB-type) may include one or more of styrene-butadiene (SB), styrene isoprene (SI), and hydrogenated derivatives thereof. Examples of suitable triblock polymers (ABA-type) may include one or more of styrene butadiene styrene (SBS), styrene isoprene styrene (SIS), styrene-butadiene-isoprene (SBI), or methylstyrene-isoprene-methylstyrene (MIM). Upon hydrogenation of the SBS copolymers comprising a suitable mixture of 1,4 and 1,2 isomers, a styrene-ethylene-butylene styrene (SEBS) block copolymer is obtained. Hydrogenation of an SIS polymer may yield a suitable styrene-ethylene-propylene-styrene (SEPS) block copolymer. VECTOR 4111 is a suitable SIS block copolymer (ABA-type), which is commercially available from Dexco Corporation (Houston Tex.). In one embodiment, a conjugated diene portion of the block copolymer may be about 90% saturated, or may be from about 90% to about 95% saturated, or may be more saturated than about 95%.

In one embodiment, the selectively hydrogenated block copolymer may have a structure as shown below in formula (I):
Bₙ(AB)ₒAₚ (I)
where n=0 or 1; o=1 to 100; p=0 or 1; each B prior to hydrogenation may be a polymerized conjugated diene hydrocarbon block, and may have a number average molecular weight in a range of from about 20,000 to about 450,000; and, each A may be a polymerized vinyl aromatic hydrocarbon block, and may have a number average molecular weight in a range of from about 2000 to about 115,000. In one embodiment, blocks of A may constitute about 5% to about 95% by weight of a copolymer; and, an unsaturation of block B may be less than about 10% of an original unsaturation level. In other embodiments, unsaturation of block B may be reduced, relatively, upon hydrogenation to less than 5% of the original value, and the average unsaturation of the hydrogenated block copolymer may be reduced to less than 20% of the original value.

Suitable commercially available maleated and selectively hydrogenated copolymers of styrene and butadiene include KRATON brand products, which are commercially available from Kraton Polymers (Houston, Tex.). KRATON D, G, FG, IR and Liquid polymers include styrenic block copolymers (SBCs) based on feedstocks of styrene, butadiene and isoprene. In one embodiment, styrene may be polymerized with butadiene, isoprene, or both. KRATON D polymers may be elastic and flexible. KRATON G polymers may be SBCs with a hydrogenated midblock, and may be elastic, flexible, and include enhanced oxidation and weather resistance, higher service temperatures and a relatively increased processing stability. KRATON FG polymers may have improved adhesion to polar substrates such as metals and nylons. KRATON IR polymers may include anionically polymerized polyisoprene rubbers, which may yield polyisoprene rubbers with a relatively low gel content and chemical impurity level. Other suitable block copolymers may be commercially available from Nippon Zeon Co. (Tokyo, Japan), for example, QUINTAC 3530, which may include a linear styrene-isoprene-styrene (SIS) block copolymer.

In one embodiment, a hydrocarbon polymer may include one or more of styrene compounds (e.g., styrene, carboxylated styrene, or alpha-methyl styrene), ethylene, propylene, butylene, and conjugated dienes (e.g., butadiene, isoprene and copolymers of butadiene and isoprene).

Examples of suitable vinyl and vinylidene halides may include one or more of vinyl chloride, vinylidene chloride, vinyl fluoride and vinylidene fluoride. In one embodiment, a vinyl ester may include aliphatic vinyl esters. Suitable vinyl esters may include one or more of vinyl formate, vinyl acetate, vinyl propionate, vinyl butyrate, vinyl isobutyrate, vinyl valerate, and vinyl caproate. Suitable vinyl esters may include allyl esters of saturated monocarboxylic acids, such as allyl acetate, allyl propionate, and allyl lactate. Suitable vinyl ethers may include one or more of methylvinyl ether, ethylvinyl ether, and n-butylvinyl ether. Suitable vinyl ketones may include one or more of methylvinyl ketone, ethylvinyl ketone, and isobutyl vinyl ketone.

Suitable ethylenically unsaturated polymers may include alkyl esters and dialkyl esters; ethylenically unsaturated carboxylic acids; nitriles, vinyl and vinylidene halides, and amides of unsaturated carboxylic acids; mono- and polyunsaturated hydrocarbon polymers; vinyl esters (e.g., vinyl esters of C1 to C6 saturated monocarboxylic acids); vinyl ethers; and amino polymers. Ethylenically unsaturated monocarboxylic acids may include methacrylic acid, ethacrylic acid, and crotonic acid. Ethylenically unsaturated dicarboxylic acids may include maleic acid, fumaric acid, itaconic acid, and citraconic acid. Suitable ethylenically unsaturated tricarboxylic acids may include aconitic acid, and halogen-substituted derivatives thereof (e.g., alphachloracylic acid), and the anhydrides of these acids (e.g., maleic anhydride and citraconic anhydride). Suitable dialkyl esters of ethylenically unsaturated dicarboxylic acids may include one or more of dimethyl maleate, diethyl maleate, dibutyl maleate, dioctyl maleate, diisooctyl maleate, dinonyl maleate, diisodecyl maleate, ditridecyl maleate, dimethyl fumarate, diethyl fumarate, dipropyl fumarate, dibutyl fumarate, dioctyl fumarate, diisooctyl fumarate, didecyl fumarate, dimethyl itaconate, diethyl itaconate, dibutyl itaconate, and dioctyl itaconate.

As noted hereinabove, an adhesive may include a hot melt adhesive. A suitable hot melt pressure sensitive adhesive may include one or more of HM-1597, HL-2207-X, HL-2115-X, HL-2193-X, which are commercially available from H.B. Fuller Company, (St. Paul, Minn.); or H2187-01, which is commercially available from Ato Findley, Inc. (Wauwatusa, Wis.). Other suitable hot melt pressure sensitive adhesives may include those commercially available from Century Adhesives Corporation (Columbus, Ohio).

The adhesive compositions also may include one or more additives. Suitable additives may include a toughening agent, tackifying polymer, wax, wetting agent, antioxidant, heat stabilizer, light stabilizer, ultraviolet light absorber, filler, colorant, pigment, opacifier, antiblocking agent, reinforcing agent, processing acid, fire retardant additive, biocide, anti-mildew agent, defoamer, flow agent, elastomer, plasticizer, thixotropic agent, suspension agent, water repellant additive, modifier, curing agent, hardening agent, flexibilizer, catalyst, and the like. In one embodiment, an adhesive may include a curing agent or hardener.

A suitable toughening agent may include insoluble in situ polymerized elastomeric particles that are formed from amine terminated polyethers, for example, diprimary amine endcapped poly(tetramethyleneoxides). Other suitable toughening agents may include amine-terminated butadiene/nitrile rubbers, carboxyl-terminated butadiene/nitrile rubbers, and core shell materials.

Suitable tackifying polymers may include a solid tackifier polymer component. A solid tackifier may have a softening point above 80 degrees Celsius. When the solid tackifier polymer component is present, the adhesive compositions may include from about 40 to about 80% by weight of a thermoplastic elastomer component and from about 20% to about 60% by weight, and in one embodiment from about 55 to about 65% by weight of a solid tackifier polymer component. A solid tackifier may reduce the modulus of the mixture to build tack or adhesion. Also, solid tackifiers (particularly the higher molecular weight solid tackifiers may be less sensitive to migration into the polymer base layer, and this is desirable Suitable tackifying polymers may have an average molecular weight of less than about 2000, about 2000, or greater than about 2000; and, may have a dispersity (Mw/Mn) of about 1, in a range of from about 1 to about 2, from about 2 to about 3, or greater than about 3.

Suitable solid tackifier polymers may include polyterpene polymers, hydrocarbon polymers, synthetic tackifier polymer, rosin, hydrogenated rosin, rosin esters, and the like. A suitable polyterpene polymer may include ZONATAC brand polymers from Arizona Chemical Company, Inc. (Jacksonville, Fla.). A suitable petroleum hydrocarbon polymer may include ESCOREZ brand polymer from Exxon Chemical Company. A commercially available synthetic tackifier polymer may include WINGTACK 95 available from Goodyear Corporation (Akron, Ohio).

The adhesive compositions may contain inorganic fillers and other organic and inorganic additives to provide desired properties. Suitable fillers may include one or more of calcium carbonate, titanium dioxide, silicon carbide, metal particles, fibers, and the like. Flame retardants may include one or more of ethylene bis pentabromo biphenyl, brominated bisphenol, halogenated metal oxide, or antimony trioxide.

Suitable modifiers may include one or more vinyl ester polymers such as styrene, vinyl 2-ethylhexanoate, vinyl caprate, vinyl laurate, vinyl pelargonate, vinyl hexanoate, vinyl propionate, vinyl decanoate, and vinyl octanoate. In one embodiment, a modifier may be present in an amount in the range of from about 0.1 weight percent to about 1 weight percent (based on the total weight of all the polymerizable polymers in the polymer mixture), from about 1 weight percent to about 20 weight percent, from about 20 weight percent to about 50 weight percent, or greater than about 50 weight percent.

A suitable modifier may include a liquid rubber. A suitable liquid rubber may have an average molecular weight of less than about 5,000, in a range of from about 5,000 to about 20,000, or greater than about 20,000. Incorporation of liquid rubbers in amounts of less than 5 weight percent, or in a range of from about 5 weight percent to about 10 weight percent, based on the overall weight of the adhesive formulation, may aid to form an adhesive which may be coextrudable with a base layer. A modulus of an adhesive may be relatively lowered by the incorporation of one or more liquid rubber. In one embodiment, incorporation of a liquid rubber into an adhesive may produce an adhesive having increased tack and/or adhesion, and may lower the glass transition temperature of the adhesive. Liquid block copolymers, such as liquid styrene-isoprene block copolymers may be used, for example, a liquid polyisoprene obtained by depolymerization of high molecular weight polyisoprene. An example of a commercially available depolymerized high molecular weight polyisoprene may be ISOLENE D-400 from Elementis Performance Polymers, (Belleville, N.J.). Other suitable liquid rubbers which may be incorporated into an adhesive may include one or more of liquid styrene-butadiene rubbers, liquid butadiene rubbers, ethylene-propylene rubbers, and the like.

A suitable curing agent may serve to crosslink a two-part adhesive. In one embodiment, a curing agent may be a multifunctional organic compound capable of reacting with functional groups located within the adhesive. Suitable curing agents may include amines, amides, phenols, thiols, carboxylic acids, carboxylic anhydrides, and mixtures thereof. In one embodiment, a curing agent may include polyoxyalkyleneamine. In one embodiment, a curing agent may include one or more anhydrides, such as cis-1,2-cyclohexane dicarboxylic anhydride, methyl hexohydropthalic anhydride, and mixtures thereof. A curing agent may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

A hardener may improve a curing reaction. Suitable hardeners may include amine hardeners, such as isophorone diamine, triethylene tetraamine, diethylene triamine, amino ethylpiperazine, 1,2- and 1,3-diaminopropane, 2,2-dimethyl propylenediamine, 1,4-diaminobutane, 1,6-diaminohexane, 1,7-diaminoheptane, 1,8-diaminooctane, 1,9-diaminononae, 1,12-diaminododecane, 4-azaheptamethylene diamine, N,N-bis(3-aminopropyl)butane-1,4-diamine, cyclohexane diamine, dicyandiamine, diamide diphenyl methane, diamide diphenyl sulfonic acid (amine adduct), 4,4-methylene dianiline, diethyltoluene diamine, m-phenylene diamine, melamine formaldehyde, tetraethylene pentamine, 3-diethylamino propylamine, 3,3-imino bis propylamine, 2,4-bis(p-aminobenzyl)aniline, tetraethylene pentamine, 3-diethylamino propylamine, 2,2,4- and 2,4,4-trimethylhexa methylene diamine, 1,2- and 1,3-diamino cyclohexane, 1,4-diamino-3,6-diethyl cyclohexane, 1,2-diamino-4-ethyl cyclohexane, 1,4-diamino-3,6-diethylcyclohexane, 1-cyclohexyl-3,4-dimino-cyclohexane, 4,4-diamino dicyclo hexylmethane, 4,4-diamino dicyclo hexylpropane, 2,2-bis(4-aminocyclohexyl)propane, 3,3-dimethyl-4,4-diamino dicyclohexyl methane, 3-amino-1-cyclohexane aminopropane, 1,3- and 1,4-bis(aminomethyl)cyclohexane, m- and p-xylylene diamine, and mixtures thereof. In one embodiment, an amine hardeners includes melamine formaldehyde. A hardening agent may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

Suitable flexibilizers may include one or more of silicone polymer additives, including fumed and unfumed silica; alumina polymer additives, including fumed and unfumed alumina; polysulfide rubbers; and mixtures of two or more thereof. Flexibilizers may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

Suitable catalysts may include substances that contain an unshared pair of electrons in an outer orbital, including Lewis Bases such as tertiary amines, imidazoles, and imidazolines. In one embodiment, a catalyst may include one or more of 2-ethyl-4-methyl-imidazole, N-(3-aminopropyl)imidazole, 2-phenyl-2-imidazoline, and mixtures of two or more thereof. A catalyst may be added to an adhesive in an amount of less than about 1 weight percent, in a range of from about 1 weight percent to about 2 weight percent, from about 2 weight percent to about 5 weight percent, from about 5 weight percent to about 10 weight percent, or greater than about 10 weight percent.

In one embodiment, an adhesive may have a glass transition temperature (T_{g}) (measured by differential scanning calorimetry) in a range of less than about 0 degrees Celsius, less than about −10 degrees Celsius, or in a range of from about −30 degrees Celsius to about −10 degrees Celsius. In one embodiment, an adhesive may have a glass transition temperature in a range of from about 0 degrees Celsius to about 20 degrees Celsius, or in a range of from about 20 degrees Celsius to about 50 degrees Celsius, or higher.

In one embodiment, an adhesive may have an adhesion strength that is equal to or greater than the cohesive strength of the adhesive, a substrate to which the adhesive layer is secured, or both. Lap shear tests conducted using steel to steel one inch lap shears with both 0 mil gaps and 5 mil gaps for the bond-line, and pulled according to ASTM 700, which is incorporated by reference, at room temperature, at 50 degrees Celsius and at 100 degrees Celsius. Results are reported in pounds per square inch (PSI) required to break the lap shear.

In one embodiment, an adhesive may have lap shear test adhesive strengths at room temperature of less than 10 PSI, in a range of from about 10 psi to about 100 PSI, from about 100 PSI to about 200 PSI, from about 200 PSI to about 250 PSI, from about 250 PSI to about 300 PSI, or greater than about 300 PSI. In one embodiment, an adhesive may have lap shear test adhesive strengths at about 50 degrees Celsius of less than 10 PSI, in a range of from about 10 PSI to about 100 PSI, from about 100 PSI to about 200 PSI, from about 200 PSI to about 250 PSI, from about 250 PSI to about 300 PSI, or greater than about 300 PSI. In one embodiment, an adhesive may have lap shear test adhesive strengths at about 100 degrees Celsius of less than 10 PSI, in a range of from about 10 PSI to about 100 PSI, from about 100 PSI to about 200 PSI, from about 200 PSI to about 250 PSI, from about 250 PSI to about 300 PSI, or greater than about 300 PSI.

An adhesive layer may contain one or more pigments to enhance the opacity and/or affect the perceived color of a base layer overlying it, and may permit the use of thinner paint base layers to achieve desired levels of opacity. Suitable pigments may include titanium dioxide and carbon black. The pigment volume concentration may range up to about 2 weight percent, from about 5 weight percent to about 8 weight percent, from about 8 weight percent to about 10 weight percent, or greater than about 10 weight percent.

Suitable antioxidant compounds may include hindered phenolic and amine antioxidant compounds. Suitable antioxidants may be commercially available from Ciba-Geigy or Novartis (Basel, Switzerland) under the general trade designations IRGANOX and IRGAFOS. In one embodiment, an adhesive includes one or more hindered phenolic antioxidant selected from n-octadecyl 3-(3,5-di-t-butyl-4-hydroxyphenol)-proprionate, which is commercially available as IRGANOX 1076 and IRGANOX 1010, is identified as Tetrakis(methylene 3-(3N,5N-di-tert-butyl-4N-hydroxyphenol)proprionate)methane. Alternatively or additionally, suitable antioxidant compounds may include hydroquinone-based antioxidants, such as 2,5-di-tertiary-amyl-hydroquinone.

Light stabilizers, heat stabilizers, and UV absorbers also may be included in the adhesive compositions. Suitable ultraviolet absorbers may include benzo-triazol derivatives, hydroxy benzyl phenones, esters of benzoic acids, oxalic acid, diamides, and the like. Suitable light stabilizers may include hindered amine light stabilizers. Suitable heat stabilizers may include dithiocarbamate compositions such as zinc dibutyl dithiocarbamate. A Suitable end-block reinforcing agent may include CUMAR LX509 from Neville Resins (Pittsburgh, Pa.).

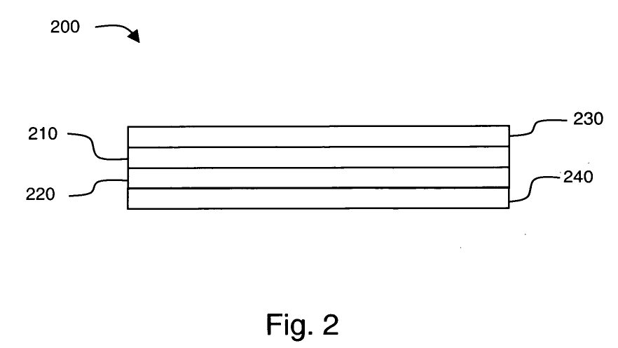

A covering article 200 comprising another embodiment is shown in FIG. 2 the covering article 200 includes a base layer 210, an adhesive layer 220, a first release layer 230, and an optional second release layer 240. The base layer 210 and the adhesive layer 220 each may have one or more of a composition, property, or thickness that is the same, or substantially the same, as a corresponding layer shown in FIG. 1.

A suitable thickness for release layers may be less than about 1.5 micrometers, in a range of from about 1.5 micrometers to about 5 micrometers, in a range of from about 5 micrometers to about 10 micrometers, or greater than about 10 micrometers.

A release layer may include a single coat of release coating material or multiple coats of release coating material. When multiple coats are used, each coat may have the same formulation, or may have a relatively different formulation. A release layer may facilitate separation of layers in response to a separating force or operation, such as unrolling. Because a reduced amount of adhesion may be useful to hold a covering article in place prior to use, a release layer may include any of the above disclosed binders, resins, or tackifiers to increase tack or adherence of the release layer to any layer against which it may be disposed or contacted, such as a base layer, graphic layer, cover layer, and the like. An increase in tack and/or adhesion may aid in reducing or preventing premature separation of a release layer from an adjacent layer during the making of the covering article, or normal handling and/or installation of the covering article, and yet may retain sufficient release properties to provide for facilitated separation between the release layer and any adjacent layer at an appropriate time during installation or application.

In one embodiment, a release layer may include a silicone. A silicone release layer may include a polyorganosiloxane, such as polydimethylsiloxane. A silicone release layer may be curable at about room temperature, may be thermally cured, or may be radiation cured. Suitable room temperature and thermally curable silicone compositions may include a polyorganosiloxane, and may further include one or more of a catalyst, cure accelerator, adhesion promoter, or curing agent.

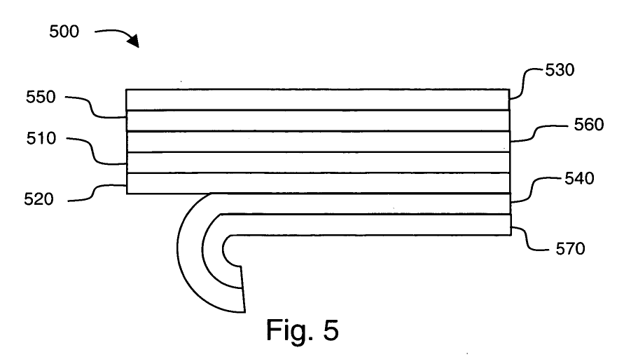

Suitable release layers may include an alkyd resin and/or a vinyl resin cross linked with a melamine resin. An alkyd resin may include a resin formed by the condensation of one or more polyhydric alcohols with one or more polybasic acids or anhydrides. Polyhydric alcohols may include glycerol and the polybasic acids or anhydrides include phthalic anhydride. Modified alkyds having a polybasic acid substituted in part by a monobasic acid such as acrylic acid or a vegetable oil fatty acid may be used. Suitable vinyl resins may include polyvinyl chloride, polyvinyl acetate, copolymers of vinyl chloride and vinyl acetate, acrylic resins, methacrylic resins, polystyrene resins, and the like. The melamine resins include amino resins made by the condensation of melamine with formaldehyde or a compound capable of providing methylene bridges. The cross linking of the alkyd and/or vinyl resin with the melamine resin may occur when a release layer is applied to a backing liner (see FIG. 5, e.g.) and dried or cured.

In one embodiment, a release layer may include, on a solids basis, less than about 1 weight percent, from about 1 weight percent to about 10 weight percent, from about 10 weight percent to about 25 weight percent, from about 25 weight percent to about 50 weight percent, from about 50 weight percent to about 75 weight percent, or greater than about 75 weight percent of resin, where the resin is an alkyd resin, a vinyl resin, or a melamine resin.

In one embodiment, a release layer-forming fluid may be applied to a first surface of a backing liner, using one of the application techniques described herein (e.g., gravure), and the release layer-forming fluid may be cured to form a release layer supported on a surface of the backing layer. In one embodiment, a base layer-forming fluid may be applied to an exposed surface of the release layer using one of the above indicated application techniques (e.g., reverse roll or slot die) and then dried or cured. An adhesive layer-forming fluid may then applied to an exposed surface of the base layer using one of the above indicated application techniques (e.g., slot die) and then may be dried or cured. In one embodiment, a pressure sensitive adhesive may be applied using transfer lamination.

In one embodiment, a release layer may include one or more structures that project from the surface of the release layer into an adjacent layer, such as a base layer, a graphic layer, a cover layer, or the like to provide the adjacent layer with a matte finish, a textured finish, semi-gloss finish, or flat finish. By contrast, not using such structures may be a method to allow for a glossy finish. When structures are present, a release layer may be referred to as a matte release layer. Suitable structure-forming materials may include a filler and/or a pigment described above for use in a base layers, such as talc or aluminum silicate. Structures having an irregular shape or a geometric shape (e.g., a plate, pyramid, or cube shape) may be used. Selecting the structure properties, disposition, and amount, allows control of a surface finish of an exterior or outward facing surface of a covering article.

Suitable amounts of structure-forming materials may include a weight ratio of structure-forming materials to polymer of greater than about 1:1, in a range of from about 1:1 to about 0.9:1, from about 0.9:1 to about 0.7:1, or less than about 0.7:1.

In one embodiment, a release force required to separate a release layer from one or more of a base layer, cover layer, backing layer, or graphic layer may be selected to be greater than the release force required to separate a release layer and/or a backing layer from an adhesive layer. In one embodiment, a release force required to separate a release layer from one or more of a base layer, cover layer, backing layer, or graphic layer may be selected to be less than the release force required to separate an adhesive layer from a substrate surface. In one embodiment, a release force required to separate a release layer from one or more of a base layer, cover layer, backing layer, or graphic layer may be less that about 20 grams per two linear inches (g/2 in), in a range of about 20 g/2 in to about 30 g/2 in, from about 30 g/2 in to about 40 g/2 in, from about 40 g/2 in to about 50 g/2 in, from about 50 g/2 in to about 60 g/2 in, from about 50 g/2 in to about 60 g/2 in, from about 60 g/2 in to about 70 g/2 in, from about 70 g/2 in to about 90 g/2 in, from about 90 g/2 in to about 100 g/2 in, from about 100 g/2 in to about 120 g/2 in, from about 120 g/2 in to about 180 g/2 in, or greater than about 180 g/2 in.

In one embodiment, a release force required to separate a release layer from an adhesive layer may be less that about 20 grams per two linear inches (g/2 in), in a range of about 20 g/2 in to about 30 g/2 in, from about 30 g/2 in to about 40 g/2 in, from about 40 g/2 in to about 50 g/2 in, from about 50 g/2 in to about 60 g/2 in, from about 50 g/2 in to about 60 g/2 in, from about 60 g/2 in to about 70 g/2 in, from about 70 g/2 in to about 90 g/2 in, from about 90 g/2 in to about 100 g/2 in, from about 100 g/2 in to about 120 g/2 in, from about 120 g/2 in to about 180 g/2 in, or greater than about 180 g/2 in. A test method for determining a release force may include measuring a force required to separate a two-inch wide release layer coated liner from a layer of interest, or from an adhesive coated substrate, with the release layer coated liner extending at an angle of 90 degrees relative to the layer or substrate and a pull rate of 300 inches per minute. The test may be conducted at room temperature.

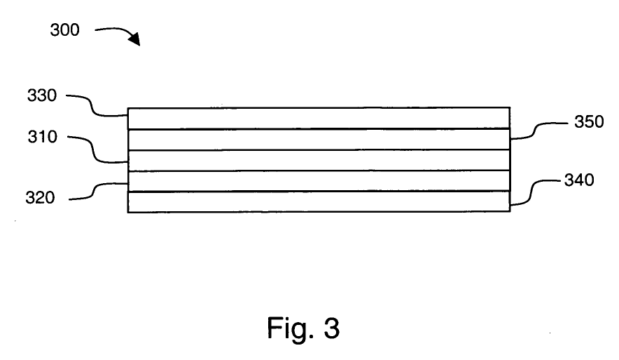

A covering article 300 comprising another embodiment is shown in FIG. 3 the covering article 300 includes a base layer 310, an adhesive layer 320, a first release layer 330, a second release layer 340, and a top coat or cover layer 350. The layers 310, 320, 330, and 340 each may have one or more of a composition, property, or thickness that is the same, or substantially the same, as a corresponding layer shown in FIGS. 1 and 2.

A suitable thickness of a cover layer may be less than about 1.5 micrometers, in a range of from about 1.5 micrometers to about 5 micrometers, in a range of from about 5 micrometers to about 10 micrometers, or greater than about 10 micrometers.

Suitable materials for forming a cover layer may include one or more of polyvinyl chloride, and copolymers of vinyl chloride and acrylic or methacrylic acid. In one embodiment, the cover layer may be translucent or transparent, and optionally may be colorless. A suitable cover layer may be one or more of scuff resistant, stain resistant, abrasion resistant, water resistant, temperature resistant, ultraviolet light resistant, and/or re-coatable. Re-coatable refers to facilitating a subsequent application of another adhesive-backed base layer or printed decorative layer, or an application of conventional paint or wall coverings (e.g., wall paper) thereto. In one embodiment, a cover layer may have a roughened surface to reduce gloss, the roughened or matte surface

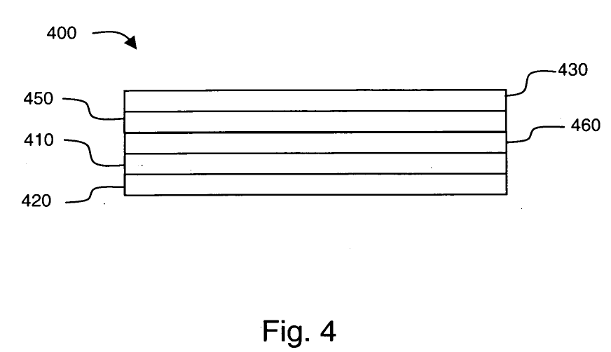

A covering article 400 comprising another embodiment is shown in FIG. 4 the covering article 400 includes a base layer 410, an adhesive layer 420, a release layer 430, a cover layer 450, and a graphic layer 460. The layers 410, 420, 430, and 450 each may have one or more of a composition, property, or thickness that is the same, or substantially the same, as a corresponding layer shown in FIGS. 1-3. In the illustrated embodiment, the graphic layer 460 is shown disposed between the cover layer 450 and the base layer 410. In alternative embodiments, a graphic layer may be disposed between other layers, for example, between an adhesive layer and a transparent base layer, or over a cover layer, and the like. Additionally, a graphic layer may be one of a plurality of like or dissimilar graphic sub-layers, each of which may be disposed adjacent to each other, between other layers, or both. In embodiments where a plurality of graphic sub-layers are adjacent to each other, the graphic sub-layers may be combined, or secured to each other, prior to forming a covering article, or may be added separately to a covering article in discrete steps.

A suitable thickness for a graphic layer may. be less than about 1.5 micrometers, in a range of from about 1.5 micrometers to about 5 micrometers, in a range of from about 5 micrometers to about 10 micrometers, or greater than about 10 micrometers.

In one embodiment, a graphic layer may be applied to a surface of a base layer. In one embodiment, a graphic layer may be sandwiched between an adhesive layer and a transparent or translucent base layer. In one embodiment, a graphic layer may be sandwiched between a base layer and a transparent or translucent cover layer.

A graphic layer may be applied using a printing technique described hereinabove (e.g., gravure, flexographic, silk screen, ink jet, and the like). A coat weight for a graphic layer may be less than about 0.25 grams per square meter (gsm), in a range of from about 0.25 gsm to about 0.5 gsm, from about 0.5 gsm to about 0.75 gsm, from about 0.75 gsm to about 1 gsm, from about 1 gsm to about 2 gsm, from about 2 gsm to about 5 gsm, or greater than about 5 gsm.

In one embodiment, the graphic layer includes a graphic design selected from blue sky without clouds, blue sky with clouds, blue sky with sun and/or clouds, canopy of green leaves, metallic pattern, stucco, fall colors leaves arrangement, three dimensional appearing appliqué, geometric patterns, solid colors, faux finishes, wood, wood paneling, animals, starry night, moon and stars, human visage(s), stone, flowers, mosaic, tiles, and the like, and combinations of two or more thereof.

A covering article 500 comprising another embodiment is shown in FIG. 5 the covering article 500 includes a base layer 510, an adhesive layer 520, a first release layer 530, a second release layer 540, a cover layer 550, a graphic layer 560, and a removable backing liner 570 that supports the second release layer 540. The layers 510, 520, 530, 540, 550, and 560 each may have one or more of a composition, property, or thickness that is the same, or substantially the same, as a corresponding layer shown in FIGS. 1-4.

A suitable thickness of the backing liner may be less than about 10 micrometers, in a range of from about 10 micrometers to about 25 micrometers, in a range of from about 25 micrometers to about 50 micrometers, or greater than about 50 micrometers. As used herein, thickness is a dry film thickness, unless context or language indicates otherwise.

A suitable backing liner may include one or more of paper, polymer film, metal film, and the like. A backing liner, in one embodiment, may be thermally stable, non-elastomeric and non-stretchable at room temperature, and may provide for one or more of antiblocking, antistatic, dimensional stability, and recyclability.

Suitable paper backing liners may include one ore more of clay coated paper, glassine, polymer coated paper, hemp, and other cellulosic materials. Suitable cellulosic materials may be prepared by such processes as the soda, sulfite or sulfate (Kraft) processes, the neutral sulfide cooking process, alkali-chlorine processes, nitric acid processes, semi-chemical processes, and the like. In one embodiment, a paper backing liner may have a weight of less than about 30 pounds per ream, in the range of from about 30 to about 60 pounds per ream, in the range of from about 100 to about 120 pounds per ream, or greater than about 120 pounds per ream. The term “ream” as used herein equals 3000 square feet.

Suitable polymer backing liners may include a polymer film formed from one or more of polyolefin, polyester, and the like. A suitable polyolefin film may include polymer and copolymers of mono-olefins having from about 2 carbon atoms to about 4 carbon atoms, and from about 4 carbon atoms to about 8 carbon atoms, from about 8 to about 10 carbon atoms, or greater than about 10 carbon atoms per molecule. Suitable polyolefin homopolymers may include one or more of polyethylene, polypropylene, poly-1-butene, and the like. Suitable films may be extruded as a mono layer film or as a multilayer film.

In one embodiment, a backing liner may include a polycoated kraft liner. A polycoated kraft liner may include a kraft liner and a polymer coating that is coated on either one or both sides of the kraft liner. Suitable polymer coatings may include one or more of high, medium, or low density polyethylene, propylene, polyester, or other similar polymer coatings. The polymer coatings may be coated onto the kraft liner to add strength and/or dimensional stability to the kraft liner. Suitable weights of kraft liners may be less than about 30 pounds per ream, in a range of from about 30 pounds per ream to about 90 pounds per ream, or greater than about 90 pounds per ream. In one embodiment, a backing liner may include from about 10 weight percent to about 40 weight percent polymer and from about 60 weight percent to about 90 weight percent paper. For two sided coatings, a quantity of polymer film, by weight, may be approximately divided evenly between the top and bottom surface of the paper.

During use, as shown in the embodiment illustrated in FIG. 5, the second release layer 540 facilitates the backing liner 570 being peeled from the adhesive layer 520. The backing liner 570 may be discarded or recycled.

A backing liner, in one embodiment, may provide structural integrity to a covering article until the backing liner has been removed after an application of the covering article to a substrate surface. In one embodiment, a backing liner may reduce or eliminate a need to employ a semi-rigid or reinforcing backing layer in a covering article.

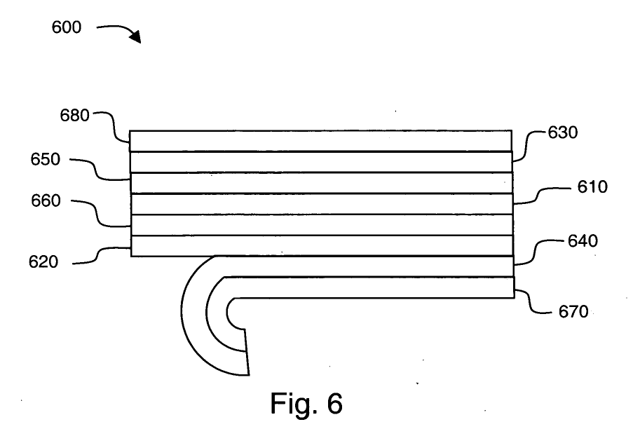

A covering article 600 comprising another embodiment is shown in FIG. 6 the covering article 600 includes a transparent base layer 610, an adhesive layer 620, a first release layer 630, a second release layer 640, a cover layer 650, a graphic layer 660, a removable backing liner 670, and a removable protective layer 680. The layers 610, 620, 630, 640, 650, 660 and 670 each may have one or more of a composition, property, or thickness that is the same, or substantially the same, as a corresponding layer shown in FIGS. 1-5.

In one embodiment, a protective layer may have a textured surface in contact with an outermost surface of a base layer, a cover layer, or a graphic layer. The textured surface may be formed by particles disposed within, or embedded or adhere to the surface of, the protective layer. The contact of the outermost surface with the textured protective layer may impart a complimentary surface finish onto the outermost surface. Peeling the protective layer away, particularly at about room temperatures, may impart the complimentary surface finish onto the outermost surface. In one embodiment, this may form a matte finish, or a satin finish.

During use, at least a portion of the removable backing liner 670 may be stripped from the adhesive layer 620 with the aid of the second release layer 640 the covering article 600 may be contacted to a substrate surface, such as a ceiling, so that the exposed adhesive layer 620 may tack or secure to the ceiling. Additional portions of the backing liner 670 may be removed and additional portions of the adhesive layer 620 may be adhered to the substrate. After the substrate surface has been sufficiently and desirably covered, and if necessary, the adhesive layer 620 may be more firmly pressed against the substrate, or may be activated using radiation or heat, to firmly secure the covering article 600 to the substrate.

In one embodiment, not shown, one or more intermediate layers may be disposed between adjacent layers, such as an adhesive layer and a base layer, or a base layer and a graphic layer. A suitable intermediate layer may include one or more of blocking layer, anti-static layer, electrostatic dispersive (ESD) layer, anti-migration layer, tie layers, adhesion promotion layers, and the like, and combinations of two or more thereof.

Suitable tie layers may include anhydride grafted polyolefins based on polyethylene (PE), polypropylene (PP), ethylene copolymers, and the like, and combinations of two or more thereof. Anhydride grafted polyolefins may provide polarity and reactivity, which may enhance adhesion on various substrates such as polyamides EVOH, PET or metals, such as aluminum. Suitable tie layer materials may be obtained from Atofina Ltd. (Paris, France) as OREVAC 18729 (see formula I, below).

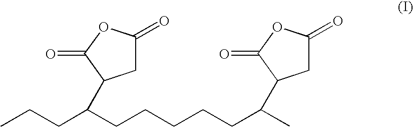

A width and length of a covering article in accordance with the invention may be selected with reference to an end use, manufacturing necessity, or other consideration. A suitable width, for example, may be in a range of from about 1 centimeter (cm) to about 10 meter. In one embodiment, a suitable width may be less than about 10 cm, in a range of from about 10 cm to about 100 cm, from about 100 cm to about 1 meter (m), from about 1 m to about 10 m, or greater than about 10 m. A suitable length may be in a range of from about 1 m to about 10 kilometers (km). In one embodiment, a suitable length may be less than about 10 m, in a range of from about 10 m to about 100 m, from about 100 m to about 1 km, from about 1 km to about 10 km, or greater than about 10 km. Articles made according to embodiments of the invention may be provided in the form of flat sheets, or may be formed into rolls.

Making a covering article comprising an embodiment of the invention, may include one or more application techniques, to include gravure, reverse gravure, offset gravure, roll coating, brushing, knife-over roll, metering rod, reverse roll coating, doctor knife, dipping, die coating, slot die coating, spraying, curtain coating, slide coating, slide curtain coating, extrusion, co-extrusion, flexographic, letter press printing, rotary screen printing, flat screen printing, flexographic printing, silk screen printing, ink jet printing, and the like. In one embodiment, an adhesive layer may include a pressure sensitive adhesive applied using transfer lamination. In one embodiment, a graphic layer may be applied using gravure, flexographic printing, silk screen printing, ink jet printing, and the like. In one embodiment, one or more release layer, base layer, cover layer, backing layer, or graphic layer may be coextruded with an adhesive layer. In one embodiment, a backing layer may be coextruded with an adhesive layer, and a base layer may be coated (e.g., gravure) onto an opposite side of the adhesive layer.

One or more layers of a covering article according to the invention may be dried and/or cured by exposure to heat, or by exposure to radiation, such as ionizing or actinic non-ionizing radiation. Drying or curing temperatures that may be used may be less than about 100 degrees Celsius, in a range of from about 100 degrees Celsius to about 115 degrees Celsius, from about 115 degrees Celsius to about 130 degrees Celsius, from about 130 degrees Celsius to about 150 degrees Celsius, or greater than about 150 degrees Celsius. Suitable types of radiation may include ultraviolet light and electron beam. Equipment for generating these forms of thermal or radiation drying and/or curing may be obtained commercially.

In one embodiment, a covering article may be a multilayer film having two or more adjacent coextruded layers. For example, a base layer may include a layer of a polyolefin and a layer of a blend of a polyolefin together with a copolymer of ethylene and vinyl acetate (EVA). In one embodiment, a base layer may include three sub-layers, for example, a core sub-layer of a polyolefin, and a skin sub-layer on each side of the core sub-layer which may include the same, or a different, polymer blend. In one embodiment, a base layer may be coextruded with an adhesive layer using separate extruders, or using a dual die extruder. A release liner may be uncoiled from a roll and advanced past a first extrusion die where the release liner may be coated with the adhesive layer, and then past a second extrusion die where a base layer may be coated onto the adhesive layer. A resulting co-extrudate may collect in sheet or in roll form. Alternatively, a release liner may be advanced past a dual extrusion die to be simultaneously coated with an adhesive layer and a base layer. The resulting co-extrudate may be collect in sheet or roll form. Alternatively, rather than collecting, the co-extrudate may be routed for coating, printing, and the like, during a single continuous manufacturing operation. A base layer may be coextruded with an adhesive layer following the above procedure.

Multi-die application methods may apply both an adhesive-forming fluid and a base-layer-forming fluid to a release liner or a temporary carrier film or belt. The base-layer-forming fluid and adhesive-forming fluid to be coextruded may be neat, may be emulsions, or may be solvent-based. When the layer forming fluid is water based or an emulsion, water may be removed in an extruder by using pressure or temperature. In one embodiment, the adhesive-forming fluid and a base-layer-forming fluid to be coextruded are substantially free (e.g., less than about 1% by weight) of water and/or solvents. Reducing the presence of water or solvents during a coextrusion process may reduce or eliminate pinholes and bubbles in a coextruded film.

A viscosity, such as a hot melt viscosity, of a base-layer-forming fluid and an adhesive-forming fluid may be controlled to be in a range of viscosities which may produce a coextrudate of continuous and/or uniform layers of the base layer and the adhesive layer. This control may reduce or eliminate film defects and intermingling of a polymeric material with adhesive during a coextrusion process. The polymeric material may have a hot melt viscosity from about 0.07 to about 1, from about 1 to about 10, or from about 10 to about 15 times the hot melt viscosity of an adhesive, particularly at a shear rate incurred during a coextrusion process. Such shear rates may range from about 100 sec-1 to about 10,000 sec-1. In one embodiment, a base-layer-forming fluid and an adhesive-forming fluid may have relatively similar melt viscosities at an extrusion temperature. For example, an adhesive may be a hot melt adhesive, and the extrusion temperatures of the adhesive may be in a range of from about 150 degrees Celsius to about 175 degrees Celsius, from about 175 degrees Celsius to about 200 degrees Celsius, or greater than about 200 degrees Celsius; the base-layer-forming fluid selected for use with the adhesive may have an extrusion temperature below about 150 degrees Celsius, in a range of from about 150 degrees Celsius to about 180 degrees Celsius, or less than about 200 degrees Celsius. The temperature differential may be used advantageously during coextrusion.

In one embodiment, one or more article-forming layers may be applied in a fluid state, and subsequently dried, cured, hardened, polymerized, or the like. A suitable coat weight for a release layer-forming fluid may be less than about 0.1 gram per square meter (gsm), in the range of about 0.1 gsm to about 1 gsm, from about 0.25 gsm to about 0.5 gsm, from about 0.5 gsm to about 1 gsm, from about 1 gsm to about 2 gsm, from about 2 gsm to about 3 gsm, from about 3 gsm to about 5 gsm, or greater than about 5 gsm. A coat weight for a base layer-forming fluid may be less than about 10 gram per square meter (gsm), in the range of about 10 gsm to about 20 gsm, from about 20 gsm to about 30 gsm, from about 30 gsm to about 40 gsm, from about 40 gsm to about 50 gsm, from about 50 gsm to about 60 gsm, from about 60 gsm to about 75 gsm, or greater than about 75 gsm. The coat weight for an adhesive layer-forming fluid may be less than about 10 gram per square meter (gsm), in the range of about 10 gsm to about 15 gsm, from about 15 gsm to about 20 gsm, from about 20 gsm to about 25 gsm, from about 25 gsm to about 30 gsm, from about 30 gsm to about 35 gsm, from about 35 gsm to about 50 gsm, or greater than about 50 gsm. One or more coats of base layer-forming fluid, adhesive layer-forming fluid, and/or release layer-forming fluid may be applied.

A suitable covering article may be made in a single production line, in multiple production lines, or in production lines in multiple production facilities. With multiple production lines or facilities, a portion of a covering article may be produced as a roll laminate, dried or cured, rolled up, transferred to a next production line or facility, unrolled, and further treated with the application of additional layers. For example, a base layer and an adhesive layer may be deposited in multiple lines, may be deposited in sequence in a single line, or may be deposited simultaneously such as by coextrusion or multi-die coating methods. Production in a single production line may reduce or eliminate handling, storage, and transporting steps for what may include, at least in one embodiment, relatively thin and delicate film materials.

During use, a covering article may be unrolled from a roll, and applied to a substrate (e.g., a ceiling) to be covered. Suitable substrates may include a flat surface having one or more of wall board, plastic sheet, metal sheet, plaster, composites, and the like. A substrate may include an interior (i.e., indoor) surface or an exterior (i.e., outdoor) surface. If necessary, the substrate surface may be prepared by cleaning, scoring, roughening, coating with an adhesion promoter, with an adhesion initiator, and the like, and combinations of two or more thereof.

If present, the release liner may be peeled from the adhesive layer the covering article may be placed over the substrate with the exposed surface of the adhesive layer in contact with the substrate the covering article may be unrolled or, if not rolled, oriented relative to the substrate surface so that the covering article covers the substrate surface and is initially secured thereto by the initial tack of the adhesive layer. If the adhesive layer is so configured, the covering article may be initially tacked to the substrate surface, and may be slide, repositioned and/or smoothed free of entrapped air bubbles prior to a more permanent securing of the adhesive layer to the substrate. More permanent securing may be achieved subsequently by applying more pressure, waiting for a period of time, heating, irradiating, and the like, and combinations of two or more thereof.

For covering articles having a thickness that is relatively small, overlapping an edge portion of the covering article with an edge portion of the next adjacently applied covering article may allow for apparent continuity of the film. The apparent continuity from sheet to adjacent sheet of applied article may be provided at least in part by the fact that the base layer may be relatively thin, and the gloss, and opacity of the base layer contribute to hide seams.

For covering articles having a thickness that is relatively large, abutting an edge portion of the covering article with an edge portion of the next adjacently-applied covering article may allow for apparent continuity of the film. The apparent continuity from sheet to adjacent sheet of applied covering article may be provided at least in part by the fact that the base layer may be relatively thick, spongy, and/or elastic. An edge of the covering article may have selvage (extending adhesive layer without a base layer), which is an unsurfaced strip that forms an under portion at the lap or an abutting edge for an adjacent sheet of material.

In one embodiment, the base layer, and/or the adhesive layer may be relatively thick, resiliently elastic, and optionally foamed. A subsequently applied adjacent sheet may be abutted to an applied sheet with a finger amount of pressure in a transverse direction so that the base layer, at least, gives and deforms in response to the pressure. After the adhesive layer contacts the substrate surface, and adheres and secures thereto, the springy base layer may return, or attempt to return, to its original shape. The two abutting edges of the elastic base layer may conform and/or mold to each other, which may contribute to hiding the seam or joint, or at least reducing its visibility or prominence. In one embodiment, the base layer is textured also. The texturing may aid further in hiding the seam or joint, or at least reducing its visibility or prominence.

A protective layer, if present over the exposed surface of the attached article, may function to protect the covering article surface from damage, such as scuffing or staining, during application. The protective layer may include graphics, such as a printed grid or measured lines or curves, to aid in cutting or shaping the covering article to tailor the covering article to the shape of the substrate surface. Alternatively or additionally, the protective layer may be ink-receptive to allow for measurement markings to be made thereon, which may facilitate cutting and shaping of the covering article for tailoring to the substrate surface. The protective layer may be removed to expose the outer most layer of the covering article, such as a cover layer (if present), graphic layer (if present), or base layer. The graphics incorporated in the protective layer, or the markings made thereon, are removed with the protective layer. If the protective layer supports a release layer or a matte release layer, the covering article may then. be imparted with a pre-determined finish.

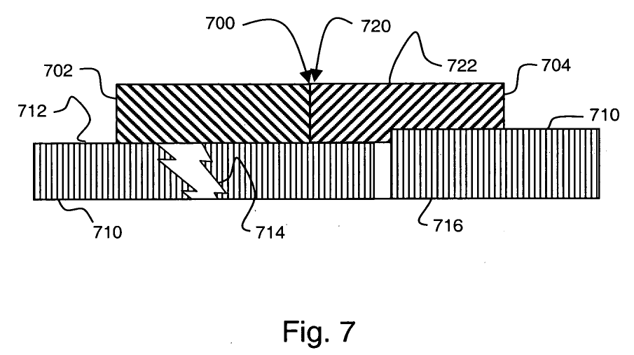

With reference to FIG. 7, peripheral edges 700 of a first portion 702 and a second portion 704 of covering articles that include embodiments of the invention are shown. As illustrated, the portions 702, 704 may be adhered to a substrate 710 having a surface 712, and a first crack 714 and a second crack 716 in the substrate surface 712. The portions 702, 704 were applied with a slight amount of force (about finger pressure) pushing them toward each other. When the slight force was removed, the resilient and elastic nature of the portions 702, 704 caused the edges 700 to appear to merge or seal at the seam 720. This may reduce the visibility of the seam 720, or obscure the presence of the seam 720.

The first portion 702 yields to a ridge 722 caused by the crack 716, which may have formed after installation or application of the portions 702, 704. By yielding, the first portion 702 may reduce the visibility of the crack 716, or obscure the presence of the crack 716.

Further, the second portion 704 bridges or stretches across the gap or crack, which may have formed after installation or application of the portions 702, 704. By stretching, rather than cracking, the second portion 704 may reduce the visibility of the crack 714, or obscure the presence of the crack 714.

### EXAMPLE 1

A transparent base layer is applied to a matte release liner using a gravure coating process at a coat weight of from about 2.7 to about 2.9 grams per square meter (gsm). The formulation for the base layer includes ingredients in amounts as follows: 35 weight percent methyl ethyl ketone, 30 weight percent toluene, 5 weight percent titanium dioxide, 5 weight percent fire retardant (tin oxide), 1 weight percent blowing agent, 2 weight percent additives (foaming agent and elastomer), 2 weight percent large diameter aggregate filler to achieve a textured-looking surface, 10 weight percent vinyl chloride/vinyl acetate copolymer containing from 5 to 20 weight percent vinyl acetate, and 10 weight percent polyester copolymer. The base layer is dried using forced hot air and/or infrared lamps at a temperature of 120 degrees Celsius. The resulting base layer is open-celled, foamed and elastomeric, having a textured or pebbly surface texture and a white color.

The base layer/release liner laminate is coated using printing method with a graphic layer. The graphic layer includes a repeating design imagine and is formed from a liquid ink composition. The ink composition is air dried, and forms a predetermined visual effect on the surface of the base layer.

An adhesive is applied to the base layer opposite the graphic layer, and at a coat weight of from about 1 to about 2 gsm. The adhesive includes a pressure sensitive acrylate adhesive.

A release liner having a release layer coated thereon is applied to an exposed surface of the adhesive layer to form a laminate covering article. The laminate is rolled and stored.

During use, the covering article is cut and shaped to follow contours and edges. The laminate is unwound from the roll and a portion of the release liner is peeled from the adhesive layer. A portion of the exposed adhesive layer is contacted with and adhered to a ceiling, and, if necessary, repositioned and/or slid into place. Additional portions of the release liner are removed from the adhesive layer, and additional portions of the adhesive layer are contacted with and adhered to the ceiling. Edges of the covering article are pressed together slightly where they abut each other. The process is repeated until the substrate surface is sufficiently covered with the covering article. The adhesive layer tenaciously adheres the covering article to the ceiling in an inverted position and does not easily release or fall.

The covering article responds to the formation of cracks in the substrate by stretching or bridging the gap formed by the crack. Similarly, if the crack edges shift and are uneven relative to each other, the elasticity of the covering article reduces or eliminates visible signs of the uneven substrate surface.

The processes and embodiments described herein may be examples of structures, systems, compositions, and methods having elements corresponding to the elements of the invention recited in the claims. This written description may enable those of ordinary skill in the art to make and use embodiments having alternative elements that likewise correspond to the elements of the invention recited in the claims. The intended scope of the claimed invention thus includes other structures, systems, compositions, and methods that do not differ from the literal language of the claims, and further includes other structures, systems, compositions, and methods with insubstantial differences from the literal language of the claims.

What is claimed is:

1. An article for covering a substrate surface, comprising:
a base layer having a first surface and a second surface, the base layer being elastic, resilient, or both elastic and resilient; and
an adhesive layer disposed on the second surface of the base layer, and which is operable to adhere to the substrate surface.

2. The article as defined in claim 1, wherein the base layer is foamed.

3. The article as defined in claim 2, wherein the base layer is open celled foam, which is capable of absorbing sound.

4. The article as defined in claim 1, wherein the base layer comprises a polymer comprising one or more of polyacrylamide, polyacrylate, polyamide, polycarbonate, epoxy, polyester, polyether, ionomer, polyolefin, polystyrene, polyurethane, polyvinyl, silicone, or polysiloxane.

5. The article as defined in claim 1, wherein the base layer has a thickness that is greater than about 25 micrometers.

6. The article as defined in claim 4, wherein the base layer has a thickness that is greater than about 50 micrometers.

7. The article as defined in claim 1, wherein the adhesive layer comprises one or more of a curable two-component adhesion resin system, pressure sensitive adhesive, structural adhesive, hot-melt adhesive, moisture curable adhesive, pressure-activated adhesive, or radiation curable adhesive.

8. The article as defined in claim 7, wherein the adhesive layer comprises one or more of a polyacrylate, polyurethane, block copolymer, epoxy, or rubber.

9. The article as defined in claim 1, wherein the adhesive layer comprises a plurality of differing adhesives, and is slideable, repositionable, or both.

10. The article as defined in claim 9, wherein the plurality of differing adhesives comprises a first pressure sensitive adhesive operable to temporarily hold the article in place during installation, and a second adhesive that has a relatively stronger adhesion relative to the first adhesive and is operable to hold the article permanently in place after final placement.

11. The article as defined in claim 1, further comprising a backing liner in releasable contact with the adhesive layer.

12. The article as defined in claim 1, further comprising a graphic layer disposed on the first surface of the base layer if the base layer is opaque, or on the first surface or the second surface of the base layer if the base layer is transparent or translucent.

13. The article as defined in claim 1, further comprising a cover layer disposed on an outermost surface of the article.

14. The article as defined in claim 13, wherein the cover layer is one or more of scuff resistant, stain resistant, abrasion resistant, water resistant, temperature resistant, ultraviolet light resistant, or re-coatable.

15. The article as defined in claim 1, further comprising a releasable protective layer disposed on an exposable surface of the article opposite the adhesive layer, the protective layer being operable to protect the exposable surface until after the adhesive layer is secured to a substrate surface, the protective layer being further operable to be removed from the exposable surface, and thereby to expose the surface of the covering article.

16. A method of covering a substrate, comprising:
securing a first covering article to a surface of the substrate, the first covering article being resilient to deformation and having a peripheral edge;
abutting the peripheral edge of the first covering article to a peripheral edge of a second covering article at a seam defined by the abutment of the respective peripheral edges, and the second article being resilient to deformation;
applying a sufficient pressure to the second covering article toward the first covering article to deform at least one of the peripheral edges;
securing the second covering article to the substrate such that there is at least some bias of the respective covering articles toward each other; and
allowing the one or more deformed peripheral edge to return to shape.

17. The method as defined in claim 16, further comprising peeling a release liner from an adhesive layer of at least one of the covering articles prior to securing the covering article to the substrate.

18. The method as defined in claim 16, further comprising peeling a cover layer from a surface of at least one of the covering articles after securing the at least one of the covering article to the substrate.

19. The method as defined in claim 16, wherein the at least one of the covering articles are responsive to a crack, flex, stain, or indent of the substrate by one or more of bridging the crack, flexing, resisting staining, or minimizing the indent.

20. A covering article, comprising:
means for covering a substrate; and
means for adhering the covering means to a surface of the substrate.
